(19) United States
(12) Patent Application Publication
(10) Pub. No.: US 2004/0160975 A1
(43) Pub. Date: Aug. 19, 2004

(54) Multicast communication protocols, systems and methods

(76) Inventors: Charles Frank, Irvine, CA (US); Thomas Ludwing, San Clemente, CA (US); Thomas Hanan, Mission Viejo, CA (US); William Babbitt, Perris, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/763,099

(22) Filed: Jan. 21, 2004

Related U.S. Application Data
(63) Continuation-in-part of application No. 10/473,713.
(60) Provisional application No. 60/441,739, filed on Jan. 21, 2003.

(51) Int. Cl. H04J 3/26

(52) U.S. Cl. 370/432

(57) ABSTRACT

A storage systems comprising a redundant array of multicast storage areas. In a preferred embodiment, such a storage system will utilize multicast devices that are adapted to communicate across a network via encapsulated packets which are split-ID packets comprising both an encapsulating packet and an encapsulated packet; and each of any split-ID packets will also include an identifier that is split such that a portion of the identifier is obtained from the encapsulated packet while another portion is obtained from a header portion of the encapsulating packet. In some embodiments, storage areas of the redundant array share a common multicast address. In the same or other embodiments the storage system will comprise a plurality of RAID sets wherein each raid set comprises a plurality of storage areas sharing a common multicast address.

This application claims the benefit of U.S. provisional application No. 60/441,739, said application being incorporated herein by reference in its entirety and by inclusion herein as Exhibit A, and is a continuation-in-part of U.S. application Ser. No. 10/473,713, filed Sep. 23, 2003, said application being incorporated herein by reference in its entirety.

### FIELD OF THE INVENTION

The field of the invention is data storage systems.

### BACKGROUND OF THE INVENTION

The acronym, RAID, was originally coined to mean Redundant Array of Inexpensive Disks. Today, however, nothing could be further from the truth. Most RAID systems are inherently expensive and non-scalable, even though clever marketing presentations will try to convince customers otherwise. All of this very specialized hardware (H/W) and firmware (F/W) tends to be very complex and expensive. It is not uncommon for a RAID controller to cost several thousands of dollars. Enclosure costs and the total cost of the RAID can run many thousands of dollars.

In the early days of RAID, different basic RAID architectures were developed to serve the diverse access requirements for data recorded on magnetic disk storage. RAID provides a way to improve performance, reduce costs and increase the reliability and availability of data storage subsystems. FIG. 1 gives a simple structural overview of the various popular systems.

There are two RAID types that deal with data at the bit and byte level. These types are RAID 2 and RAID 3 respectively. RAID 2 has never become commercially viable since it requires a lot of special steering and routing logic to deal with the striping and parity generation at the bit level. RAID 3 has been more successful working at the byte level and has been used for large file, sequential access quite effectively.

The most popular RAID in use today is RAID 1 also known as a mirror. This is due to the utter simplicity of the structure. Data is simply written to two or more hard disk drives (HDDs) simultaneously. Total data redundancy is achieved with the added benefit that it is statistically probable that subsequent reads from the array will result in lowered access time since one actuator will reach its copy of the data faster than the other. It should be noted that by increasing the number of HDDs beyond 2, this effect becomes stronger. The downside of mirrors is their high cost.

Commercial RAID implementations generally involve some form of a physical RAID controller, or dedicated F/W and H/W functionality on a network server or both. This is illustrated in FIG. 4. The RAID controller is generally architected to maximize the throughput of the RAID measured either in input/output operations per second (IOPS) or in file transfer rates. Normally this would require a set of specialized H/W (such as a master RAID controller) that would cache, partition and access the drives individually using a storage specific bus like EIDE/ATA, SCSI, SATA, SAS, iSCSI or F/C. The cost of these control elements vary widely as a function of size, capabilities and performance. Since all of these with the exceptions of iSCSI and F/C are short hop, inside-the-box, interfaces, the implementation of RAID generally involves a specialized equipment enclosure and relatively low volume products with high prices.

### SUMMARY OF THE INVENTION

An aspect of the present invention is storage systems comprising a redundant array of multicast storage areas. In a preferred embodiment, such a storage system will utilize multicast devices that are adapted to communicate across a network via encapsulated packets which are split-ID packets comprising both an encapsulating packet and an encapsulated packet; and each of any split-ID packets will also include an identifier that is split such that a portion of the identifier is obtained from the encapsulated packet while another portion is obtained from a header portion of the encapsulating packet. In some embodiments, storage areas of the redundant array share a common multicast address. In the same or other embodiments the storage system will comprise a plurality of RAID sets wherein each raid set comprises a plurality of storage areas sharing a common multicast address.

Another aspect of the present invention is a network comprising a first device and a plurality of storage devices wherein the first device stores a unit of data on each of the storage devices via a single multicast packet.

Yet another aspect of the present invention is a network of multicast devices which disaggregate at least one RAID function across multiple multicast addressable storage areas. In some embodiments the at least one RAID function is also disaggregated across multiple device controllers.

Still another aspect of the present invention is a storage system comprising a redundant array of multicast storage areas wherein the system supports auto-annihilation of mooted read requests. In some embodiments auto-annihilation comprises the first device responding to a read request commanding other devices to disregard the same read request. In other embodiments, auto-annihilation comprises a device that received a read request disregarding the read request if a response to the read request from another device is detected.

Another aspect of the present invention is a storage system comprising a dynamic mirror. In some embodiments the dynamic mirror comprises N storage devices and M maps of incomplete writes where M is at least 1 and at most 2*N. In the same or alternative embodiments the maps comprise a set of entries wherein each entry is either an logical block address (LBA) or a hash of an LBA of a storage block of a storage area being mirrored. Preferred embodiments will comprise at least one process monitoring storage area ACKs sent in response to write commands, the process updating any map associated with a particular area whenever a write command applicable to the area is issued, the process also sending an ACK on behalf of any storage area for which the process did not detect an ACK. In some embodiments updating a map comprises setting a flag whenever an ACK is not received and clearing a flag whenever an ACK is received.

The systems and networks described herein are preferably adapted to utilize the preferred storage area network (“PSAN”, sometimes referred to herein as a “mSAN” and/or “μSAN”) protocol and sub-protocols described in U.S. application Ser. No. 10/473,713. As described therein, the PSAN protocol and sub-protocols comprise combinations of ATSID packets, tokened packets, split-ID packets, and also comprises the features such as packet atomicity, blind ACKs, NAT bridging, locking, multicast spanning and mirroring, and authentication. RAID systems and networks utilizing the PSAN protocol or a subset thereof are referred to herein as PSAN RAID systems and networks. It should be kept in mind, however, that although the use of the PSAN protocol is preferred, alternative embodiments may utilize other protocols. The systems and networks described herein may use the PSAN protocol through the use of PSAN storage appliances connected by appropriately configured wired or wireless IP networks.

By using optional RAID subset extension commands under multicast IP protocol, data can be presented to an array or fabric of PSAN storage appliances in stripes or blocks associated to sets of data. It is possible to establish RAID sets of types 0, 1, 3, 4, 5, 10 or 1+0 using the same topology. This is possible since each PSAN participates autonomously, performing the tasks required for each set according to the personality of the Partition it contains. This is an important advantage made possible by the combination of the autonomy of the PSAN and the ability of the multicast protocol to define groups of participants. Performance is scalable as a strong function of the bandwidth and capabilities of IP switching and routing elements and the number of participating PSAN appliances.

RAID types 0, 1, 4, and 5 each work particularly well with PSAN. RAID types 10 and 0+1 can be constructed as well, either by constructing the RAID 1 and 0 elements separately or as a single structure. Since these types of RAID are really supersets of RAID 0 and 1, they will not be separately covered herein in any detail. The PSANs perform blocking/de-blocking operations, as required, to translate between the physical block size of the storage device and the block size established for the RAID. The physical block size is equivalent to LBA size on HDDs.

Due to the atomicity of PSAN data packets, with indivisible LBA blocks of 512 (or 530) bytes of data, providing support variable block sizes is very straightforward. Each successful packet transferred results is one and only one ACK or an ERROR command returned to the requester. Individual elements of a RAID subsystem can rely on this atomicity and reduced complexity in design. The PSAN can block or de-block data without loosing synchronization with the Host, and the efficiency is very high compared to other form of network storage protocols. However, for RAID 2 and RAID 3 the atomicity of the packet is compromised with a general dispersal of the bits or bytes of a single atomic packet among two or more physical or logical partitions. The question of which partitions must ACK or send an error response becomes difficult to resolve. It is for this reason that PSAN RAID structures are most compatible with the block oriented types of RAID.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a structural overview of basic RAID systems.

FIG. 2 is a table describing various types of basic RAID systems.

FIG. 3 depicts a typical structure of RAID Systems.

FIG. 4 depicts a PSAN multicast RAID data structure.

FIG. 5 depicts the structure of a PSAN RAID array.

FIG. 6 illustrates accessing a stripe of data in RAID 0.

FIG. 7 depicts a RAID 1 (Mirror) structure.

FIG. 8 depicts a RAID 4 structure.

FIG. 9 is a table of RAID 4 access commands.

FIG. 10 illustrates RAID 4 LBA block updates.

FIG. 11 illustrates RAID 4 full stripe updates.

FIG. 12 depicts a RAID 5 structure.

FIG. 13 is a table of RAID 5 access commands.

FIG. 14 illustrates RAID 5 LBA block updates.

FIG. 15 illustrates RAID 5 full stripe updates.

FIG. 16 illustrates data recovery operations for a read error.

FIG. 17 illustrates data recovery operations for a write error.

FIG. 18 depicts an exemplary transfer stripe command.

FIG. 19 depicts an exemplary rebuild stripe command.

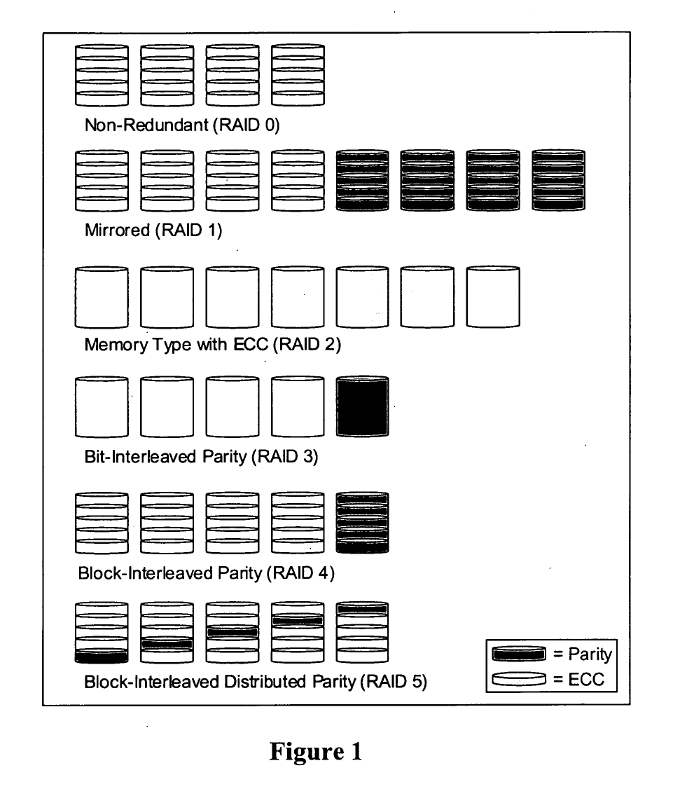

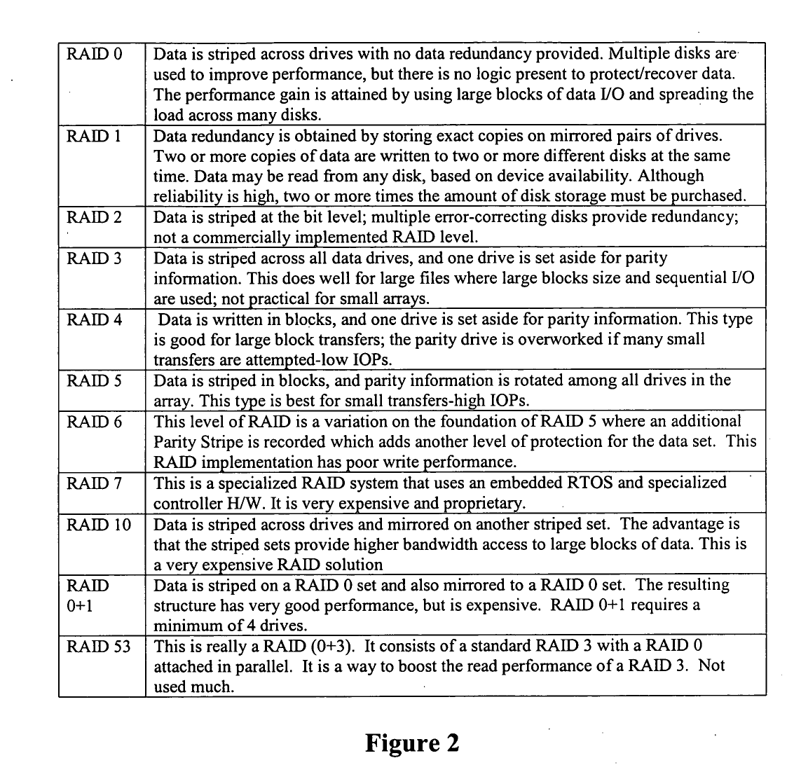

### DETAILED DESCRIPTION

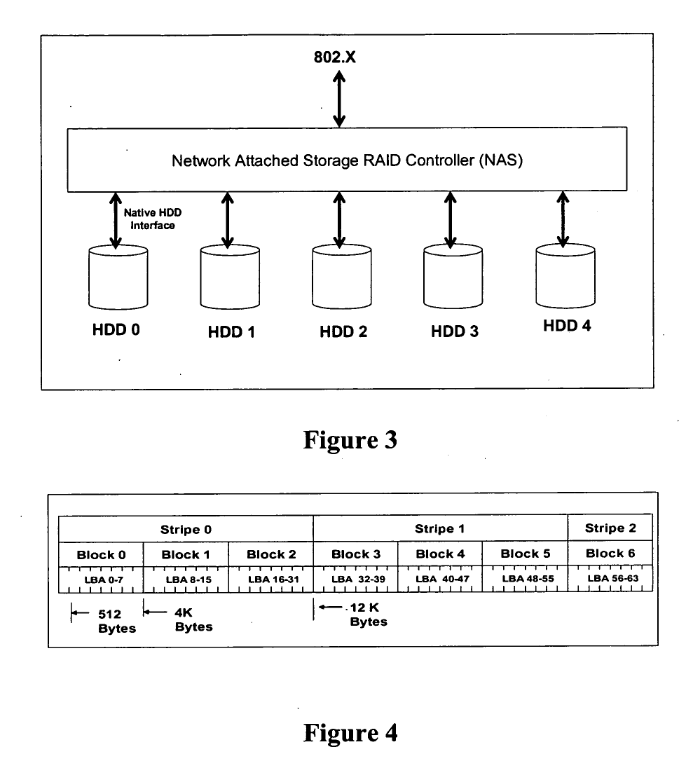

Most of the cost and complexity in the prototypical RAID structure depicted in FIG. 3 is borne within the complex and expensive RAID Controller. This function does a lot of brute force data moving, caching, parity generation and general control and buffering of the individual RAID storage elements. The PSAN RAID we are describing in this document substitutes all of this brutish, complex and expensive H/W and F/W with the elegance and simplicity of the existing and ubiquitous IP protocol and an array of PSAN storage appliance elements.

To accomplish this feat, we must look at the translation of the serial IP data stream and how it can be utilized to convey the important concepts of data sets, and stripes as well as how independent devices can imply an overlying organization to that data even though there is no additional information transmitted with the data. The reader will quickly discover that by the simple act of establishing a RAID Partition on a set of PSAN devices, the devices can autonomously react to the data presented and perform the complex functions normally accomplished by expensive H/W. The reader will also discover that many ways exist to further automate and improve the capability of such structures—up to and including virtualization of physical design elements within larger overlying architectures.

In the FIG. 4, the hierarchal nature of the Multicast Data transmission is depicted. LBA blocks are sequentially transmitted from left to right with virtual levels of hierarchy implied. It is important to note that these relationships are not imposed by the requestor in any way, but are understood to exist as interpretations of the structure imposed by the PSAN from properties assigned to the RAID partition These properties are established by the Requestor (Host) within the partition table recorded in the root of each PSAN. In other words, each PSAN knows which elements of the RAID set belong to it and what to do with them.

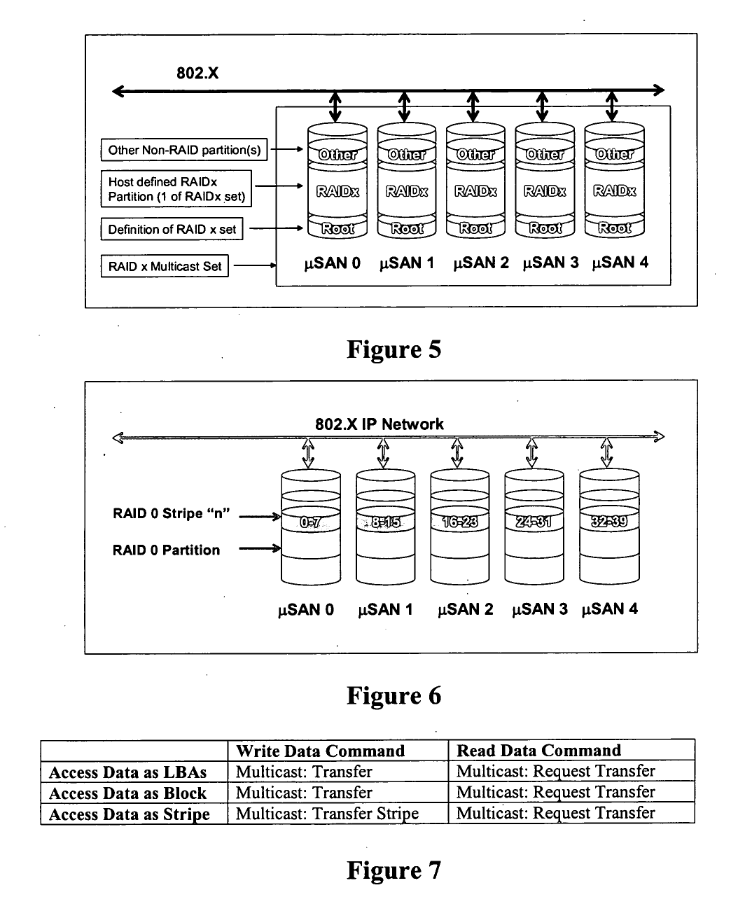

As shown in FIG. 5, a set of PSAN devices can be associated to a Multicast Set. Membership within the set is defined by definitions contained within the Root Partition of each PSAN. The root contains descriptions of all partitions within the PSAN. The Host establishes the RAID partitions using Unicast Reserve Partition commands to each PSAN that is to be associated with the set. During this transaction other important characteristics of the RAID partition are established:

Basic type of RAID—RAID 0, 1, 4, 5 or 10

RAID 5 parity rotation rules

Size of a BLOCK (usually set to 4K bytes)

ACK reporting policy

ERROR reporting policy

Buffering and Caching policy

Policy for LBA updates

Policy for Block updates

Policy for full stripe updates

Policy for data recovery

Policy for rebuilding

. . . more

After the setup of the Partition for each PSAN has been established, the Host must set the Multicast Address that the RAID will respond to. This is accomplished by issuing a “Set Multicast Address” command. Once this is established, the Host can begin accessing these PSANs as a RAID using Multicast commands. Typically, the following types of actions would be accomplished by the Host to prepare the RAID for use:

Scan all blocks to verify integrity of the media

Overlay a file system associating the LBAs

Initialize (or generate) the RAID stripes with correct parity

Perform any other maintenance actions to prepare the RAID

Once the RAID is ready for use, the Host can communicate to the RAID using standard LBA block, Block or Stripe level commands with Multicast and the RAID will manage all activities required to maintain the integrity of the data within the RAID. By selecting the proper RAID structure for the type of use expected, the performance of the RAID can be greatly improved.

Raid 0

In FIG. 6 is shown a simple representation of an array of 5 PSAN devices connected to an 802.x network. The actual construction of the 802.x network would most likely include a high-speed switch or router to effectively balance the network. One of the most important benefits of using PSAN is the effect of multiplying B/W since each PSAN has its own network connection to the switch.

Assume a simple striped RAID 0 (FIG. 6) consisting of 5 PSAN storage appliances.

All 5 PSANs have identical partitions for elements of the RAID 0

All 5 PSANs know that a stripe is 5 blocks or 40 LBAs in length

All 5 PSANs know there is no parity element within the stripe

PSAN 0 knows that block 0 (LBAs 0-7) of each stripe belong to it

PSAN 1 knows that block 1 (LBAs 8-15) of each stripe belong to it

PSAN 2 knows that block 2 (LBAs 16-23) of each stripe belong to it

PSAN 3 knows that block 3 (LBAs 24-31) of each stripe belong to it

PSAN 4 knows that block 4 (LBAs 32-39) of each stripe belong to it

All 5 PSANs see all data on the 802.3 Multicast

All 5 PSANs know who to ACK to and how to send error responses

With this established, it is a relatively simple process for the array of PSANs to follow the stream and read/write data. This process simply requires each PSANs to calculate the location of its data in parallel with the other PSANs. This is accomplished by applying modulo arithmetic to the block address of the individual packets and either ignoring them if they are out of range or accepting them if they are in range.

As can be seen in FIG. 6, the data that was sent serially on the 802.3 network was recorded as a stripe on the array of PSANs. Data can be accessed at the following levels randomly from within the array:

As a LBA-1 LBA=512 bytes, the size of a basic PSAN block

As a RAID block-1 Block=8 LBAs=4K bytes

As a full Stripe-1 Stripe=number of devices×4K bytes

The table of FIG. 7 illustrates exemplary PSAN data access commands.

Raid 1

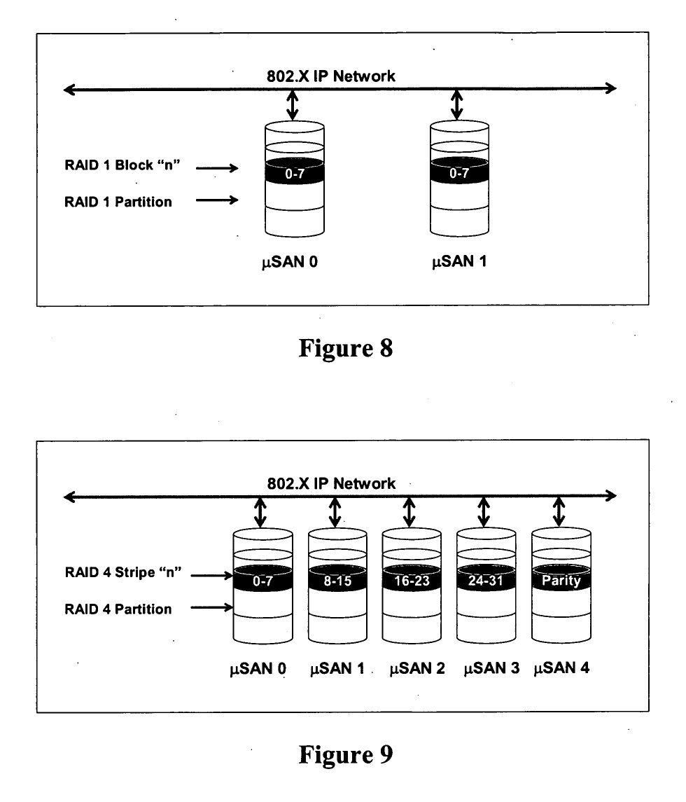

RAID 1 is the first type of RAID that actually provides redundancy to protect the data set. As can be seen from FIG. 8, the establishment of a RAID 1 array requires some form of symmetry since the mirrored elements require identical amounts of storage. For the sake of simplicity, the example in FIG. 8 shows 2 PSAN devices connected to the 802.x network.

Assume a simple RAID 1 mirror (FIG. 8) consisting of 2 PSAN storage appliances.

PSANs 0 and 1 have identical partitions for elements of the RAID 1

Both PSANs know that a stripe is 1 block or 8 LBAs in length

Both PSANs know there is no parity element within the stripe

Both PSANs know they must respond to every LBA, block or stripe access

Both PSANs see all data on the 802.3 Multicast

Both PSANs know who to ACK to and how to send error responses

Raid 4

Assume a RAID 4 (FIG. 9) consisting of 5 PSAN storage appliances.

All 5 PSANs have identical partitions for elements of the RAID 4

All 5 PSANs know that a stripe is 4 blocks or 32 LBAs in length

PSAN 0 knows that block 0 (LBAs 0-7) of each stripe belong to it

PSAN 1 knows that block 1 (LBAs 8-15) of each stripe belong to it

PSAN 2 knows that block 2 (LBAs 16-23) of each stripe belong to it

PSAN 3 knows that block 3(LBAs 24-31) of each stripe belong to it

PSAN 4 knows that it is the parity drive for each stripe

All 5 PSANs see all data on the 802.3 Multicast

All 5 PSANs know how to ACK to and how to send error responses

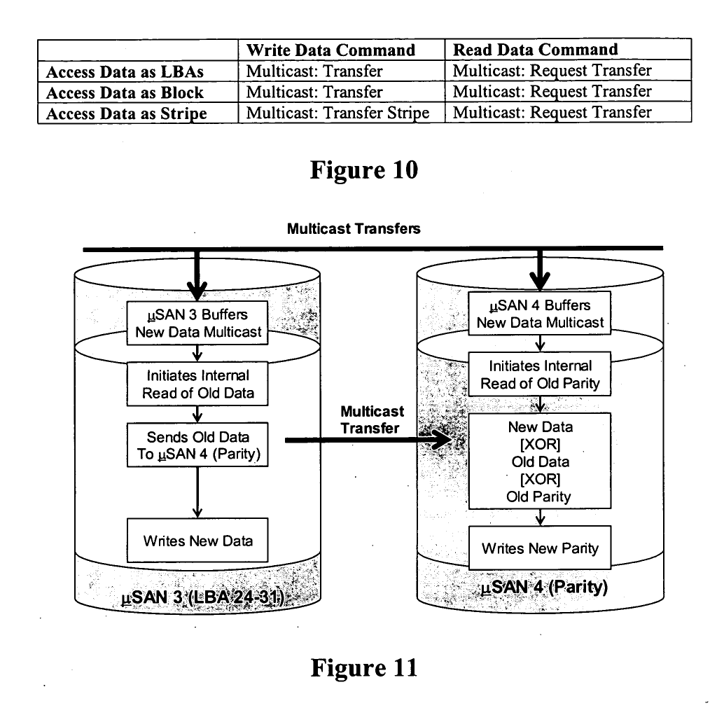

In RAID 4 configuration, the parity element, in this case PSAN 4, must monitor the data being written to each of the other PSAN elements and compute the parity of the total transfer of data to the array during LBA, block or stripe accesses. Access to the array can be at the LBA, Block or Stripe level. Each level requires specific actions to be performed by the array element in an autonomous but cooperative way with the parity element. FIG. 10 is a table listing the types of PSAN commands that are involved with the transfer of data to the array. Each access method will be supported by the commands shown. Following the table is a description of the activities the array must accomplish for each.

Raid 4 Data Access as LBA blocks or Blocks

During access by LBA blocks or Blocks for the purpose of writing data within the RAID 4 array, the Parity element, PSAN 4 in our example below, must monitor the flow of data to all other elements of the array. This is easily accomplished because the parity element is addressed as part of the multicast IP transfer to the active element within the array. In RAID 4 the parity is always the same device.

During a Transfer or Go Transfer command the RAID array is addressed as the destination, and all members of the RAID set including the parity PSAN will see the multicast data. Because this operation is a partial stripe operation, a new parity will need to be calculated to keep the RAID data set and Parity coherent. The only method to calculate a new parity on a partial update is to perform a read-modify-write on both the modified element of the RAID Set and the Parity element. This means that the infamous RAID write penalty will apply. Since the HDD storage devices within the PSANs can only read or write once in each revolution of the disk, it takes a minimum of 1 disk rotation+the time to read and write 1 LBA block to perform the read and subsequent write.

This multi-step process is depicted in FIG. 11 in a simple flowchart that clearly illustrates the relationships of operations. During the execution of this function on the two autonomous PSANs, the “Old” data is actually sent to the Parity PSAN using a Multicast Transfer command. The Parity PSAN sees this transfer as originating from within the RAID. If there is an error handling a data transfer, the Parity PSAN will send an error message to the sending PSAN. If there is no error, the Parity PSAN will simply send an ACK to the sending PSAN. This handshake protocol relieves the actual Host from becoming involved in internal RAID communications. If there is an error, then the sending PSAN can attempt to recover by resending the data or by other actions. If the operation cannot be salvaged, then the Sending PSAN will send an error message back to the Host. If all goes well, new parity is then written over the existing parity stripe element. After this operation is completed, the RAID stripe is complete and coherent.

Raid 4 Data Access as a Stripe

The benefit of RAID 4 is best realized when the Host is reading and writing large blocks of data or files within the array. It has been shown above that partial stripe accesses bear a rotational latency penalty and additional transfers to maintain coherency within the RAID array. This can be completely avoided if the requestor can use full stripe accesses during writes to the array. In fact, by setting the Block Size equal to the stripe size, RAID 4 will perform like RAID 3.

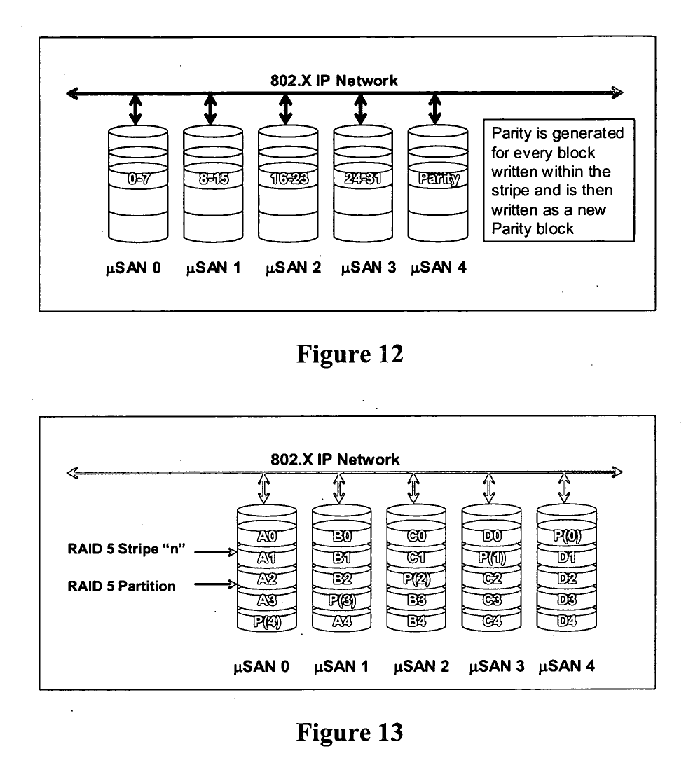

During access by Stripe for the purpose of writing data within the RAID 4 array, the Parity element, PSAN 4 in FIG. 12, must monitor the flow of data to all other elements of the array. As each LBA block is written, the parity PSAN will accumulate a complete parity block by performing a bytewise XOR of each corresponding LBA block until all of the LBA blocks have been written in the stripe. The Parity PSAN will then record the parity for the stripe and begin accumulating the parity of the next stripe. In this fashion, large amounts of data can be handled without additional B/W for intermediate data transfers. The Host sees this activity as a series of Transfer Commands with no indication of the underlying RAID operation being performed. Parity/Data coherence is assured because all data is considered in the calculations and the overwrite process ignores old parity information. This command is very useful in preparing a RAID for service.

In the event of an error, the PSAN experiencing the error is responsible for reporting the error to the Host. This is accomplished by the standard ERROR command. If there is no error, the Host will see a combined ACK response that indicates the span of LBAs that were correctly recorded.

Raid 5

Assume a RAID 5 (FIG. 13) consisting of 5 PSAN storage appliances.

All 5 PSANs have identical partitions for elements of the RAID 5

All 5 PSANs know that a stripe is 4 blocks or 32 LBAs in length

All 5 PSANs know parity element rotate across all devices

All 5 PSANs know which LBAs to act on

All 5 PSANs see all data on the 802.3 Multicast

All 5 PSANs know how to ACK and send error responses

In RAID 5 configuration, the parity element is distributed in a rotating fashion across all of the elements of the RAID. Access to the array can be at the LBA, Block or Stripe level. Therefore, depending on which stripe is being written to, the assigned parity PSAN must monitor the data being written to each of the other PSAN elements and compute the parity of the total transfer of data to the array during LBA, block or stripe accesses. Each level requires specific actions to be performed by the array element in an autonomous but cooperative way with the parity element. Below is a table listing the types of PSAN commands that are involved with the transfer of data to the array. Each access method will be supported by the commands shown. Following the table is a description of the activities the array must accomplish for each.

Raid 5 Data Access as LBA blocks or Blocks (Partial Stripe)

During access by LBA blocks or Blocks for the purpose of writing data within the RAID 5 array, the Parity element, shown in our example below, must monitor the flow of data to all other elements of the array. This is easily accomplished because the parity element is addressed as part of the multicast IP transfer to the active element within the array.

During a Transfer or Go Transfer command the RAID array is addressed as the destination, and all members of the RAID set including the parity PSAN will see the multicast data. Because this operation is a partial stripe operation, a new parity will need to be calculated to keep the RAID data set and Parity coherent. The only method to calculate a new parity on a partial update is to perform a read-modify-write on both the modified element of the RAID Set and the Parity element. This means that the infamous RAID write penalty will apply. Since the HDD storage devices within the PSANs can only read or write once in each revolution of the disk, it takes a minimum of 1 disk rotation+the time to read and write 1 LBA block to perform the read and subsequent write.

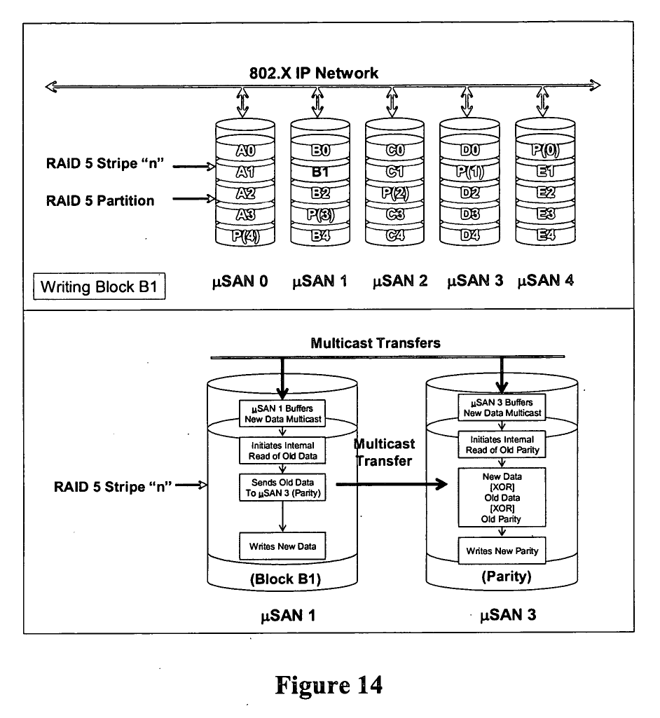

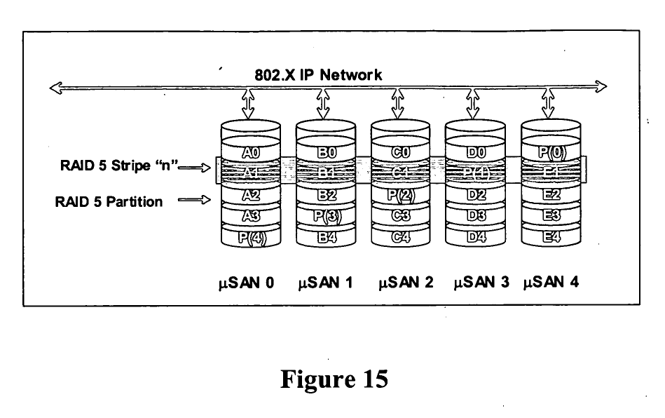

This multi-step process is depicted in FIG. 14 in a simple flowchart that clearly illustrates the relationships of operations. During the execution of this function on the two autonomous PSANs, the “Old” data is actually sent to the Parity PSAN using a Multicast Transfer command. The Parity PSAN sees this transfer as originating from within the RAID. If there is an error handling a data transfer, the Parity PSAN will send an error message to the sending PSAN. If there is no error, the Parity PSAN will simply send an ACK to the sending PSAN. This handshake protocol relieves the actual Host from becoming involved in internal RAID communications. If there is an error, then the sending PSAN can attempt to recover by resending the data or by other actions. If the operation cannot be salvaged, then the Sending PSAN will send an error message back to the Host. If all goes well, new parity is then written over the existing parity stripe element. After this operation is completed, the RAID stripe is complete and coherent.

The penalty of read-modify-write is avoided when the Host is reading and writing large blocks of data or files within the array. It has been shown above that partial stripe accesses bear a rotational latency penalty and additional transfers to maintain coherency within the RAID array. This can be completely avoided if the requestor can use full stripe accesses during writes to the array. In fact, by setting the Block Size equal to the stripe size, RAID 5 will perform like RAID 3.

During access by Stripe for the purpose of writing data within the RAID 5 array, the Parity element, PSAN 3 in our example below, must monitor the flow of data to all other elements of the array. As each LBA block is written, the parity PSAN will accumulate a complete parity block by performing a bytewise XOR of each corresponding LBA block until all of the LBA blocks have been written in the stripe. The Parity PSAN will then record the parity for the stripe and begin accumulating the parity of the next stripe. In this fashion, large amounts of data can be handled without additional B/W for intermediate data transfers. The Host sees this activity as a series of Transfer Commands with no indication of the underlying RAID operation being performed. Parity/Data coherence is assured because all data is considered in the calculations and the overwrite process ignores old parity. This command is very useful in preparing a RAID.

In the event of an error, the PSAN experiencing the error is responsible for reporting the error to the Host. This is accomplished by the standard ERROR command. If there is no error, the Host will see a combined ACK response that indicates the span of LBAs that were correctly recorded.

ERROR Recovery and Rebuilding

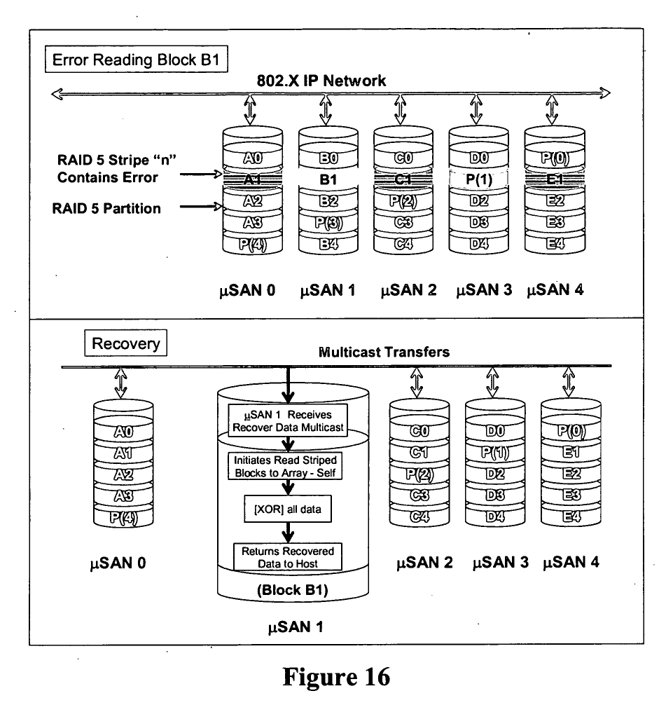

Whenever a PSAN RAID encounters an error reading data from a block within a RAID set that has redundancy information, the PSAN involved in the error will initiate a sequence of operations to recover the information for the Host. This process is automatic and returns an appropriate error condition to the requestor. The recovery of data will follow the process shown in FIG. 16.

In the case where a PSAN has encountered an error reading a block of data it will report an error to the Host indicating that it has evoked the RAID recovery algorithm and the data presented to the requestor is recovered data. There are also several conditions that may be reported concerning the error recovery process:

1. First, the error may indicate an inability of the PSAN to read or write any data on the PSAN. In that case, the PSAN must be replaced with a spare.

2. The PSAN may indicate an inability to read or write data just to a set of blocks (indicating a newly grown defect on the recording surface). In this case the requestor may utilize a direct read and copy of the failed PSAN to a designated spare for all readable blocks and only reconstruct data where the actual errors exist for recording on the spare PSAN. This method would be much faster than the process of reconstructing the entire PSAN via the use the recovery algorithm.

3. The failed block may operate properly after the recovery process. If this is the case, it may be possible for the Host to continue using the RAID without further reconstruction. The PSAN will record the failure in case it pops up again. After several of these types of failures the Host may want to replace the PSAN with a spare anyway.

Whenever a PSAN RAID encounters an error reading data from a block within a RAID set that has redundancy information, the PSAN involved in the error will initiate a sequence of operations to recover the information for the Host. This process is automatic and returns an appropriate error condition to the requestor. The recovery of data will follow the process shown in FIG. 16.

In the case where a PSAN has encountered an error writing a block of data it will report an error to the Host indicating that it has evoked the RAID recovery algorithm and the data presented by the requestor was added to the Parity record after first subtracting the old write data from the Parity. There are also several conditions that may be reported concerning the error recovery process:

1. The error may indicate an inability of the PSAN to write any data on the PSAN. In that case, the PSAN must be replaced with a spare.

2. The PSAN may indicate an inability to write data just to a set of blocks (indicating a newly grown defect on the recording surface). In this case the requester may utilize a direct read and copy of the failed PSAN to a designated spare for all readable blocks and only reconstruct data where the actual errors exist for recording on the spare PSAN. This method would be much faster than the process of reconstructing the entire PSAN via the use the recovery algorithm.

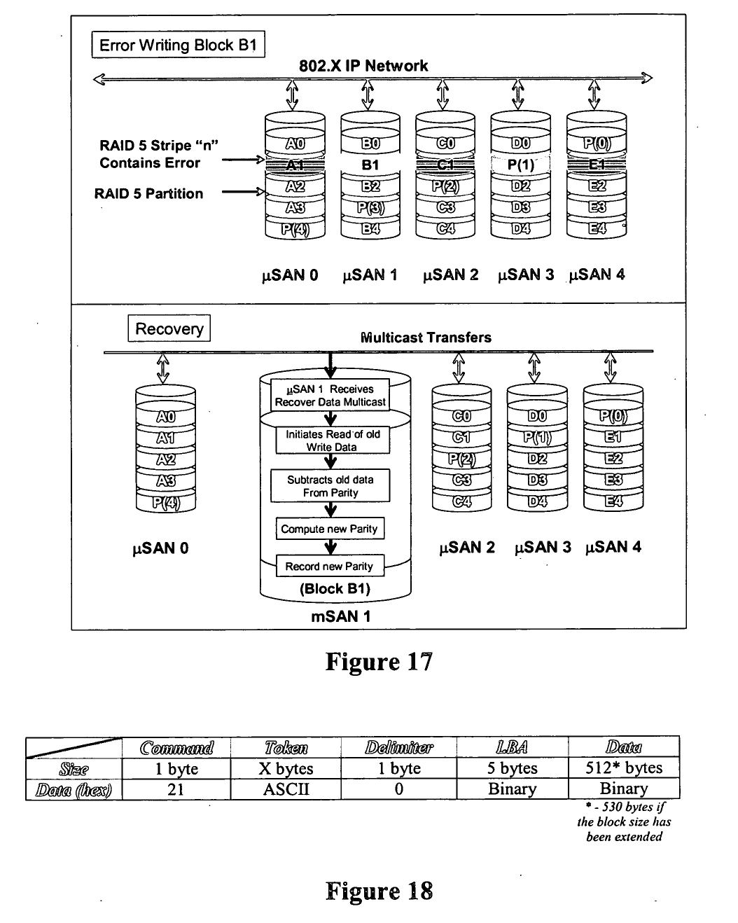

Whenever a PSAN RAID encounters an error writing data to a block within a RAID set that has redundancy information, the PSAN involved in the error will initiate a sequence of operations to recover the information for the Host. This process is automatic and returns an appropriate error condition to the requestor. The recovery of data will follow the process shown in FIG. 17.

In the case of a catastrophic failure of a PSAN within a RAID set, it may be impossible to even communicate with the PSAN. In this case the next sequential PSAN within the Multicast group will assume the responsibilities of reporting to the requestor and carrying out recovery and reconstruction processes and providing data to the Host. In effect this PSAN becomes a surrogate for the failed PSAN.

The requestor can choose to instruct the failed PSAN or the surrogate to rebuild itself on a designated Spare PSAN so that RAID performance can be returned to maximum. During the rebuilding process, the failed RAID device essentially clones itself to the designated spare drive.

RAID Superset Commands

These commands are a superset of the basic PSAN command set detailed in the PSAN White Paper Revision 0.35 and are completely optional for inclusion into a PSAN. Base level compliance with the PSAN protocol excludes these commands from the basic set of commands. The PSAN RAID Superset commands follow a master/slave architecture with the Requester as the master. The format follows the standard format of all PSAN commands, but is intended to operate exclusively in the Multicast protocol mode under UDP. This class of commands is specifically intended to deal with the aggregation of LBA blocks into stripes within a previously defined RAID association. A PSAN receiving a command in this class will perform specific functions related to the creation, validation and repair of data stripes containing parity.

Transfer Stripe Command

This command (see FIG. 18) is used to transfer the data either as a write data to the PSAN or the result of a request from the PSAN. One block of data is transferred to the Multicast address contained within the command. The Parity member is defined by the partition control definition at the root of the PSAN members of a RAID set. The method of recording blocks on specific elements within the RAID array is also defined. By using these definitions, each PSAN within the RAID is able to deal with data being written into the array and able to compute the parity for the entire stripe. During the first block transfer into a stripe, the requestor will clear a bitmap of the LBA blocks contained in the stripe and preset the Parity seed to all zero's (h00). The initial transfer block command and all subsequent transfers to the stripe will clear the corresponding bit in the bit map and add the new data to the parity byte. In a write from Requester operation, this is the only command that is transferred from the Requester. The PSAN responds with an ACK Command. This command may be sent to either Unicast or multicast destination IP addresses.

Rebuild Stripe Command

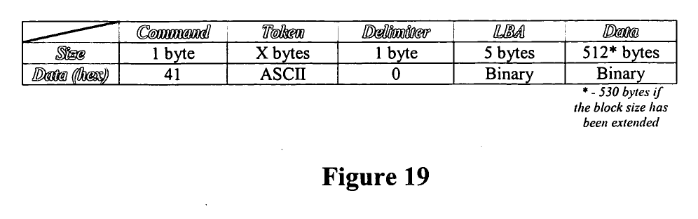

This command (see FIG. 19) is used to repair a defective stripe in a pre-assigned RAID structure of PSAN elements. This command is sent via Multicast protocol, to the RAID set that has reported an error to the Requestor. The defective PSAN or surrogate (if the defective PSAN cannot respond) will rebuild the RAID Data Stripe on the existing RAID set substituting the assigned spare PSAN in place of the failed PSAN. The rebuild operation is automatic with the designated PSAN or surrogate PSAN performing the entire operation.

Although the user may construct a RAID Set association among any group of PSAN devices using the Standard Command set and RAID superset commands, the resulting construction may have certain problems related to non-RAID partitions being present on PSAN devices that are part of a RAID set. The following considerations apply:

1. RAID access performance can be impaired if high bandwidth or high IOP operations are being supported within the non-RAID partitions. The fairness principles supported by the PSAN demand that every partition receives a fair proportion of the total access available. If this is not considered in the balancing and loading strategy, the performance of the RAID may not match expectations.

2. In the event of a failure in a RAID set device, the RAID set elements will begin a recovery and possibly a rebuilding process. Depending on the decision of the Requestor/Owner of the RAID set, the PSAN RAID set element that has failed may be taken out of service and replaced by a spare (new) PSAN. Since the RAID set owner most likely will not have permission to access the non-RAID partitions, those partitions will not be copied over to the new PSAN. The PSAN that failed, or its surrogate, will issue a Unicast message to each Partition Owner that is affected, advising of the impending replacement of the defective PSAN device. It will be up to the Owner(s) of the non-RAID partition(s) as to the specific recovery (if any) action to take.

For these reasons, it is preferred that RAID and non-RAID partitions do not exist within a single PSAN. If such action is warranted or exists, then individual Requestor/Owners must be prepared to deal with the potential replacement of a PSAN.

Auto Annihilate

Auto Annihilate is a function intended to significantly improve the performance and efficiency of broadcast and multicast based reads from PSAN mirrors on multiple devices. This class of added function uses existing band or dedicated messages to optimize performance by eliminating transmission and seek activities on additional mirrored elements once any element of the mirror has performed, completed or accepted ownership of a read command. This enables all additional elements to ignore or cancel the command or data transfer depending on which action will conserve the greatest or most burdened resources.

In a typical array of two or more PSAN mirrored element(s), element(s) would monitor the PSAN bus to determine if and when another element has satisfied or will inevitably satisfy a command and subsequently remove that command from it's list of pending command or communication. This feature becomes increasingly beneficial as the number of elements in a mirror increases and the number of other requests for other partitions brings the drive and bus closer to their maximum throughput. This function naturally exploits caching by favoring devices with data already in the drive's ram and thereby further reducing performance robbing seeks.

By example a 3 way mirror would see a 66% reduction in resource utilization while at the same time achieving a 200% increase in read throughput. A 5 way mirror would see an 80$ reduction in resource utilization while at the same time achieving a 400% increase in read throughput.

In summary the combination of multicast and broadcast writes, eliminates redundant transfer but requires multiple IPO's and Auto Annihilate Reads eliminate redundant transfer and redundant IOP's. This is a significant improvement since most systems see 5 times as many reads as writes resulting in a naturally balanced systems fully utilizing the full duplex nature of the PSAN bus.

In one instance the elements within an array of mirrored elements send a specfic broadcast or multicast ANNIHILATE message on the multicast address shared by all elements of the mirror allowing each of the other welements to optionally cancel any command or pending transfer. Transfers which are already in progress would be allowed to complete. It should also be noted that the host shall be able to accept and/or ignore up to the correct number of transfers if none of the elements support an optional Auto Annihilate feature.

Dynamic Mirror

Dynamic Mirrors are desirable in environments where one or more elements of the mirror are expected to become unavailable but it is desirable for the mirrors to resynchronize when again available. A classic example of such a situation would be a laptop which has a network mirror which is not accessible when the laptop is moved outside the reach of the network where the mirror resides. Just as a Dynamic Disk is tolerant of a storage area appearing or disappearing without loosing data a Dynamic Mirror is tolerant of writes to the mirrored storage area which take place when the mirrored storage areas can not remain synchronized.

uSAN Dynamic Mirrors accomplish this by flagging within a synchronization map which blocks were written while the devices were disconnected from each other. LBA are flagged when an ACK is not received from a Dynamic Mirror.

Synchronization is maintained by disabling reads to the unsynchronized Dynamic Mirror at LBA which have been mapped or logged as dirty (failing to receive an ACK) by the client performing the write. When the Storage areas are again re-connected ACK's from the mirror are again received from the Dynamic Mirror for writes. The Mirror however remains unavailable for read requests to the dirty LBA flagged in the MAP until those LBA have been written to the Dynamic Mirror and an ACK has been received.

Synchronizing a Dirty Dynamic Mirror could be done by a background task on the client which scans the Flag Map and copies data from the Local Mirror storage area to the dirty Dynamic Mirror.

To accelerate Synchronization of Dirty Dynamic Mirrors a write to an LBA flagged as Dirty will automatically remove the Flag when the ACK is received from the Dynamic Mirror. Once all the Map Flags are clear the Local and Dynamic Mirror(s) are synchronized and the Dynamic Mirror(s) represents a completely intact backup of the Local Mirror.

It is foreseen that a local mirror would keep an individual MAP for each Dynamic Mirror in it's mirrored set thereby allowing multiple Dynamic Mirrors to maintain independent levels of synchronization depending on their unique pattern of availability and synchronization.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A storage system comprising a redundant array of multicast storage areas.

2. The storage system of claim 1, wherein:
the multicast devices are adapted to communicate across a network via encapsulated packets which are split-ID packets comprising both an encapsulating packet and an encapsulated packet; and
each of any split-ID packets also includes an identifier that is split such that a portion of the identifier is obtained from the encapsulated packet while another portion is obtained from a header portion of the encapsulating packet.

3. The storage system of claim 1, wherein the storage areas of the redundant array share a common multicast address.

4. The storage system of claim 1, comprising a plurality of RAID sets wherein each raid set comprises a plurality of storage areas sharing a common multicast address.

5. A network comprising a first device and a plurality of storage devices wherein the first device stores a unit of data on each of the storage devices via a single multicast packet.

6. A network of multicast devices which disaggregate at least one RAID function across multiple multicast addressable storage areas.

7. The network of claim 6 wherein the at least one RAID function is also disaggregated across multiple device controllers.

8. A storage system comprising a redundant array of multicast storage areas wherein the system supports auto-annihilation of mooted read requests.

9. The system of claim 8 wherein auto-annihilation comprises the first device responding to a read request commanding other devices to disregard the same read request.

10. The system of claim 9 wherein auto-annihilation comprises a device that received a read request disregarding the read request if a response to the read request from another device is detected.

11. A storage system comprising a dynamic mirror.

12. The storage system of claim 11 wherein the dynamic mirror includes a mirrored storage area and at least one corresponding map of incomplete writes.

13. The storage system of claim 11 wherein the dynamic mirror comprises N storage devices and M maps of incomplete writes where M is at least 1 and at most 2*N.

14. The storage system of claim 13 wherein the map comprises a set of entries wherein each entry is either an LBA or a hash of an LBA of a storage block of a storage area being mirrored.

15. The system of claim 13 comprising at least one process monitoring storage area ACKs sent in response to write commands, the process updating any map associated with a particular area whenever a write command applicable to the area is issued, the process also sending an ACK on behalf of any storage area for which the process did not detect an ACK.

16. The system of claim 55 wherein updating a map comprises setting a flag whenever an ACK is not received and clearing a flag whenever an ACK is received.
